(19) United States
(12) Patent Application Publication
(10) Pub. No.: US 2014/0234799 A1
(43) Pub. Date: Aug. 21, 2014

(54) Dental Crown Removal Apparatuses and Methods of Using the Same

(71) Applicant: Dental USA, Inc., McHenry, IL (US)

(72) Inventor: Jang H. Lim, McHenry, IL (US)

(73) Assignee: Dental USA, Inc., McHenry, IL (US)

(21) Appl. No.: 14/183,975

(22) Filed: Feb. 19, 2014

Related U.S. Application Data
(60) Provisional application No. 61/766,386, filed on Feb. 19, 2013.

(51) Int. Cl. A61C 3/16; A61C 3/00

(52) U.S. Cl. CPC A61C 3/162; A61C 3/00
USPC 433/159; 433/172; 433/218

(57) ABSTRACT

A dental crown removal apparatus easily and efficiently removes dental crowns, caps or other dental implants from a tooth. Specifically, the present invention provides a dental crown removal apparatus having a first elongated beak and a second elongated beak arranged in a pliers-type arrangement. The first elongated beak has a first beak portion angularly extending from a first handle, and a second beak portion angularly extending from the first beak portion, the first elongated beak engaging the top of a crown, cap or other dental implant. Moreover, the second elongated beak extends angularly from the second handle, the first beak portion of the first elongated beak and the second elongated beak arranged in parallel when the apparatus is in a closed configuration. Methods of using the same are further provided.

### CROSS-REFERENCE TO RELATED APPLICATIONS

This application claims the benefit of U.S. Provisional Application Ser. No. 61/766,386 filed on Feb. 19, 2013. The '386 application is hereby incorporated by reference.

### TECHNICAL FIELD OF THE INVENTION

The present invention relates to a dental crown removal apparatus and methods of using the same. Specifically, the present invention provides a dental crown removal apparatus for easily and efficiently removing a dental crown implant. Methods of using the same are further provided.

### BACKGROUND OF THE INVENTION

It is, of course, generally known to place or replace a covering over a tooth. In the art, this is known as a crown or cap, and may be placed over a tooth that may be damaged to protect the same. In the past, precious metals had been used to create a close facsimile of the person's original crown, the replacement crown held in place by cements. In modern times, other materials are typically utilized, such as ceramics or complex mixtures. These materials must be rigid and strong, easily take the shape of a dental crown, easily held in place on a person's tooth using cements, and look and feel like the original dental crown.

Sometimes, crowns, caps or other dental implants may require removal from a person's tooth due to damage to the crown, cap or other implant. Removal may also be required if further work must be done on the person's tooth under the crown, such as when a root canal must be performed. In such cases, it is often required to remove the crown, cap or other implant to access the tooth beneath. Due to difficulty in removing the crown, cap or other dental implant, specialized tools needed to be developed. More specifically, cements that are typically utilized to hold a crown, cap or other implant in place on a person's tooth make it very difficult for removal of the crown, cap or other implant.

For example, pliers-type devices have long been used to loosen or remove a crown, cap or other implant from a person's mouth. Through the years, improvements have been made in the configuration of dental tools for engaging the crown, cap or other implant and/or the surrounding tissue to make it more convenient for removal.

Specifically, U.S. Pat. No. 4,609,353 to Kline discloses a pliers-type apparatus for removal of a crown or cap. The apparatus has upper and lower opposing jaw portions with the lower jaw including a tapered and pointed member for engaging the lower marking of a crown and wherein the upper jaw portion supports an axially offset and rotatable pin member which may be adjustably positioned so as to apply pressure over a cusp and along the elongated axis of a tooth through a predrilled opening in the upper portion of a crown so that opposing pressure may be applied by the upper and lower jaw portions of the instrument to lift and separate the crown from a tooth. However, U.S. Pat. No. 4,609,353 includes an upper jaw portion and a lower law portion in vertical alignment with each other, making it difficult to leverage the same to remove the crown, cap or other implant from a tooth. More specifically, the lower jaw portion that engages the lower marking of a crown and the upper jaw portion that applies pressure over a cusp of the crown must be aligned relatively close together, limiting the leverage one may obtain when attempting to remove the crown, cap or other implant.

In addition, U.S. Pat. No. 5,833,460 to Maeda discloses a dental implement having two moderately flexible hemostat-like handle enabling an operator to apply force through finger and thumb grips to bring coplanar bracing and grasping beaks toward one another for gentle removal of crowns or bridges from the mouth of a patient. The bracing beak bearing on the occlusal surface of an underlying tooth is readily modifiable in length or angular position to accommodate a variety of tooth sizes, locations and orientations, and the grasping beak is hollow ground to provide enhanced purchase on a gingival margin or supra marginal notch of a crown. However, because the bracing and grasping beaks are coplanar, the dental implement of U.S. Pat. No. 5,833,460 limits the leverage that may be applied to the crown, cap or other dental implant, making it difficult to easily and effectively remove the crown, cap or other dental implant from a patient's tooth.

A need, therefore, exists for a dental crown removal apparatus and methods of using the same that allows a user to easily and effectively remove a crown, cap or other dental implant from a patient's mouth. More specifically, a need exists for a dental crown removal apparatus and methods of using the same that provides a user with increased leverage to effectively break the cementitious bond between a crown, cap or other implant and a patient's tooth.

Moreover, a need exists for a dental crown removal apparatus and methods of using the same allowing a user to grasp a pair of handles in pliers-type apparatus to impart sufficient pressure and force against a crown, cap or other dental implant to remove the same from a patient's tooth. In addition, a need exists for a dental crown removal apparatus and methods of using the same that provides sufficient gripping means for a user to handle the same and provide the sufficient leverage.

Further, a need exists for a dental crown removal apparatus and methods of using the same having an upper jaw and a lower jaw having beaks that are offset one from another for easily engaging different portions of a crown, cap or other dental implant. Still further, a need exists for a dental crown removal apparatus and methods of using the same wherein a lower beak includes a notched surface for engaging a crown, cap or other dental implant on a side of a crown, cap or other dental implant where the crown, cap or other dental implant meets the tooth of the patient, and a surface on an upper beak for engaging the top or cusp of the crown, cap or other dental implant, the two beaks engaging simultaneously and sufficient force applied by a user of the same for removing the crown, cap or other dental implant from the patient's tooth.

### SUMMARY OF THE INVENTION

The present invention relates to a dental crown removal apparatus and methods of using the same. Specifically, the present invention provides a dental crown removal apparatus for easily and efficiently removing a dental crown implant. Methods of using the same are further provided.

To this end, in an embodiment of the present invention, a dental apparatus is provided. The dental apparatus comprises a first handle and a second handle, the first handle rotatably engaged with the second handle to form a pliers-type apparatus having an open configuration and a closed configuration; a first elongated beak extending from the first handle, the first elongated beak having a first beak portion angularly extending from the first handle and a second beak portion angularly extending from the first beak portion, the second beak portion having a terminal end for engaging a top of a crown, cap or dental implant; and a second elongated beak extending angularly from the second handle, wherein the first beak portion and the second elongated beak are parallel to each other when the apparatus is in a closed configuration.

In an embodiment, the dental apparatus further comprises a terminal end on the second beak portion for engaging a top of a crown, cap or dental implant.

In an embodiment, the terminal end has a surface, wherein the surface has a texture.

In an embodiment, the texture comprises a plurality of bumps.

In an embodiment, the first beak portion extends at about a ninety degree angle from the first handle.

In an embodiment, the second beak portion extends at about a ninety degree angle from the first beak portion.

In an embodiment, the first beak portion extends at about a ninety degree angle from the first handle, and the second beak portion extends at about a ninety degree angle from the first beak portion.

In an embodiment, the second elongated beak extends at about a ninety degree angle from the second handle.

In an embodiment, the dental apparatus further comprises a notch in the second elongated beak for engaging a crown, cap or tooth.

In an alternate embodiment of the present invention, a system is provided. The system comprises a dental apparatus and further comprises a dental implant engaged to a tooth, wherein the second beak portion of the first elongated beak contacts a top of the dental implant and the second elongated beak engages the side of the dental implant.

In an embodiment, the dental implant is selected from the group consisting of a crown and a cap.

In an alternate embodiment of the present invention, a method of using a dental apparatus is provided. The method comprises the steps of: providing a dental apparatus comprising a first handle and a second handle, the first handle rotatably engaged with the second handle to form a pliers-type apparatus having an open configuration and a closed configuration; a first elongated beak extending from the first handle, the first elongated beak having a first beak portion angularly extending from the first handle and a second beak portion angularly extending from the first beak portion, the second beak portion having a terminal end for engaging a top of a crown, cap or dental implant; and a second elongated beak extending angularly from the second handle, wherein the first beak portion and the second elongated beak are parallel to each other when the apparatus is in a closed configuration; engaging the second beak portion of the first elongated beak with a top of the crown, cap or dental implant; engaging the second elongated beak with a side of the crown, cap or dental implant; and prying the crown, cap or dental implant from a tooth using the dental apparatus.

In an embodiment, the dental apparatus further comprises a terminal end on the second beak portion for engaging a top of the crown, cap or dental implant.

In an embodiment, the terminal end has a surface, wherein the surface has a texture.

In an embodiment, the texture comprises a plurality of bumps.

In an embodiment, the first beak portion extends at about a ninety degree angle from the first handle.

In an embodiment, the second beak portion extends at about a ninety degree angle from the first beak portion.

In an embodiment, the first beak portion extends at about a ninety degree angle from the first handle, and the second beak portion extends at about a ninety degree angle from the first beak portion.

In an embodiment, the second elongated beak extends at about a ninety degree angle from the second handle.

In an embodiment, the dental apparatus further comprises a notch in the second elongated beak for engaging the crown, cap or dental implant.

It is, therefore, an advantage and objective of the present invention to provide a dental crown removal apparatus and methods of using the same that allows a user to easily and effectively remove a crown, cap or other dental implant from a patient's mouth.

More specifically, it is an advantage and objective of the present invention to provide a dental crown removal apparatus and methods of using the same that provides a user with increased leverage to effectively break the cementitious bond between a crown, cap or other implant and a patient's tooth.

Moreover, it is an advantage and objective of the present invention to provide a dental crown removal apparatus and methods of using the same allowing a user to grasp a pair of handles in pliers-type apparatus to impart sufficient pressure and force against a crown, cap or other dental implant to remove the same from a patient's tooth.

In addition, it is an advantage and objective of the present invention to provide a dental crown removal apparatus and methods of using the same that provides sufficient gripping means for a user to handle the same and provide the sufficient leverage.

Further, it is an advantage and objective of the present invention to provide a dental crown removal apparatus and methods of using the same having an upper jaw and a lower jaw having beaks that are offset one from another for easily engaging different portions of a crown, cap or other dental implant.

Still further, it is an advantage and objective of the present invention to provide a dental crown removal apparatus and methods of using the same wherein a lower beak includes a notched surface for engaging a crown, cap or other dental implant on a side of a crown, cap or other dental implant where the crown, cap or other dental implant meets the tooth of the patient, and a surface on an upper beak for engaging the top or cusp of the crown, cap or other dental implant, the two beaks engaging simultaneously and sufficient force applied by a user of the same for removing the crown, cap or other dental implant from the patient's tooth.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A and 1B illustrate mirror image dental apparatuses for removing a crown, cap or other dental implant in an embodiment of the present invention.

FIG. 2 illustrates a dental apparatus engaged within a crown for removal of the same in an embodiment of the present invention.

FIGS. 3A and 3B illustrate mirror image dental apparatus having spring-loaded handles for removing a crown, cap or other dental implant in an embodiment of the present invention.

### DETAILED DESCRIPTION OF THE INVENTION

The present invention relates to a dental crown removal apparatus and methods of using the same. Specifically, the present invention provides a dental crown removal apparatus for easily and efficiently removing a dental crown implant. Methods of using the same are further provided.

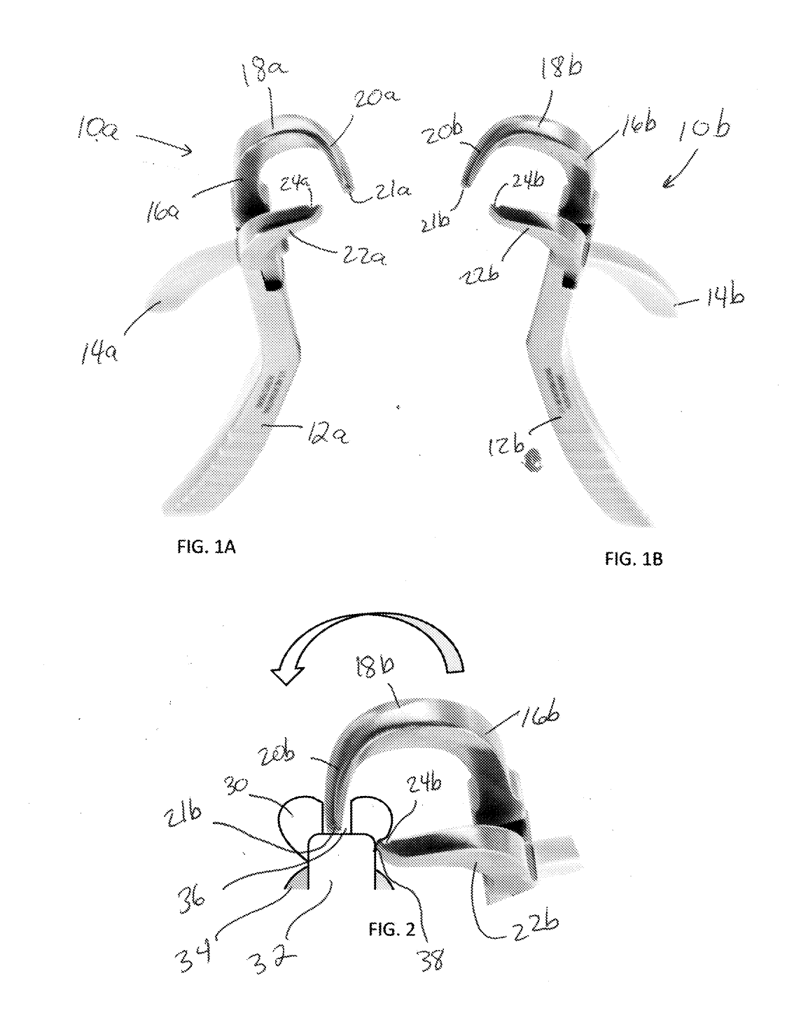

Referring now to the figures, wherein like numerals refer to like parts, a dental apparatuses 10a, 110b are illustrated in FIGS. 1A and 1B. Specifically, dental apparatuses 10a, 10b may be identical in shape, size and features, except that dental apparatus 10b may be a mirror image of dental apparatus 10a. More specifically, dental apparatuses 10a, 10b may have a chirality or “handedness”, allowing the apparatuses to be used in different locations in a patient's mouth to engage and remove a crown, cap or other dental implant on a patient's tooth. For example, dental apparatus 10a may be to engage certain crowns, caps or other dental implants situated on a certain side of the patient's mouth and/or on an upper jaw or lower jaw of the patient. Dental apparatus 10b may be utilized to engage crowns, caps or other dental implants on an opposite side of the patient's mouth, as apparent to one of ordinary skill in the art.

Dental apparatuses 10a, 10b may each have a first handle 12a, 12b, and a second handle 14a, 14b, respectively. The first handle 12a, 12b may be rotatably engaged with second handle 14a, 14b, respectively, to form a pliers-type apparatus, the handles 12, 12b and 14a, 14b rotating with respect to each other inwardly and outwardly.

Extending from the first handle 12a, 12b may be an elongated beak 16a, 16b, respectively, the elongated beak having a first beak portion 18a, 18b extending at an angle from the handle 12a, 12b. Preferably, the first beak portion 18a, 18b may extend at roughly ninety degrees (90°) from the first handle 12a, 12b. A second beak portion 20a, 20b may extend at an angle relative to the first beak portion 18a, 18b, respectively. Preferably, the second beak portion 20a, 20b may extend downwardly at roughly ninety degrees (90°) from the first beak portion 18a, 18b, respectively. Thus, the second beak portion 20a, 20b may be disposed downwardly to engage the top or cusp of a crown, cap or other dental implant, when the handles are gripped by a user thereof, as illustrated in FIG. 2.

The second beak portion 20a, 20b may have a terminal endpoint 21a, 21b forming a surface on an end thereof, the surface having a texture to ensure that the terminal endpoint 21a, 21b does not slip from a crown, cap or other dental implant when engaging the same, as illustrated below in FIG. 2. The texture may be a roughened surface, and/or a pattern comprising bumps, pits, lines, or other like features allowing the terminal endpoint 21a, 21b to engage with crown, cap or other dental implant without excessive slipping of the same when engaged. Because slippage is minimized, a user of the dental apparatus 10a, 10b may be provided increased leverage to remove the crown, cap or other dental implant, as illustrated below in FIG. 2.

Extending from the second handle 14a, 14b, respectively, may be a lower beak 22a, 22b extending at an angle from the second handle 14a, 14b. Preferably, the lower beak 22a, 22b may extend at roughly ninety degrees (90°) relative to the handle 14a, 14b, respectively. Thus, the lower beak 22a, 22b may be configured roughly parallel to the first beak portion 18a, 18b.

The lower beak 22a, 22b may have a notch 24a, 24b inset within the upper surface of the lower beak 22a, 22b, the notch useful for engaging a crown, cap or other dental implant, as illustrated below in FIG. 2.

The first handle 12a, 12b may be rotatably engaged to the second handle 14a, 14b, respectively, via an axis of rotation 15a, 15b, that may be a pin, bolt, or other axis allowing movement of the first handle 12a, 12b with respect to the second handle 14a, 14b, respectively. Movement of the first handle 12a, 12b with respect to second handle 14a, 14b may cause the opening and closing of the elongated beak 16a, 16b with respect to the lower beak portion 22a, 22b, allowing the same to be manipulated for engagement on a crown, cap or other dental implant, as illustrated below with respect to FIG. 2.

Now referring to FIG. 2, dental apparatus 1 Obis illustrated in use to remove a crown 30 that may be disposed on a tooth 32, surrounded by gum tissue 34, as may be disposed within a patient's mouth. As shown, terminal endpoint 21b may be engaged with or through a top or cusp of the crown 30, either directly on the crown 30 or, preferably, within a hole or aperture 36 that may be drilled or otherwise disposed in the crown 30, as illustrated in cross section in FIG. 2. As described above, the texture on the surface of the terminal endpoint 21b may aid the terminal endpoint 21b in engaging the tooth 32 through the crown 30 without slippage of the same.

Further, as illustrated, the notch 24b and the lower beak 22b may engage the side of the crown 30, either at the contact point where the crown meets the tooth or, as illustrated in FIG. 2, with an indentation 38 that may be cut or drilled into the side of the crown 30. The notch 24b on the lower beak 22b may engage the indentation 38, and with the engagement of the second beak portion 20b through the top or cusp of the crown 30, the user of the apparatus 10b may have sufficient leverage to rotate the apparatus 10b in the direction indicated in FIG. 2 to break the bond that the crown 30 may have with the tooth 32.

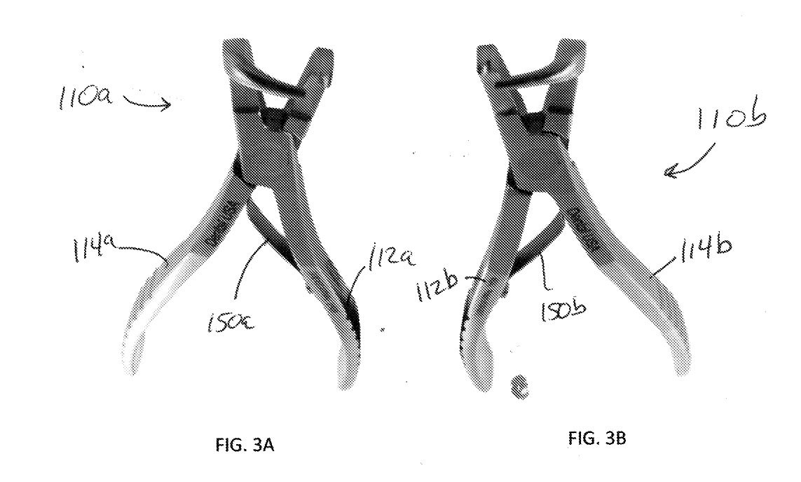

FIGS. 3A, 3B illustrate a further embodiment of the present invention of dental apparatuses 110a, 110b, which may be similar to apparatuses 10a, 10b, as described above. Specifically, dental apparatus 110a may be useful in removing crowns, caps or other dental implants on teeth on a particular side or location within a patient's mouth, and the dental apparatus 110b, being a mirror image of dental apparatus 110a, may be useful in removing crowns, caps or other dental implants on teeth in different locations within a patient's mouth.

Dental apparatuses 110a, 110b may include a spring 150a, 150b, respectively, that may be utilized to bias first handle 112a, 112b away from second handle 114a, 114b to ensure that elongated beak 116a, 116b is open relative to lower beak 122a, 122b, respectively. When a user utilizes dental apparatuses 110a, 110b, he or she may squeeze the first handles 112a, 112b and second handles 114a, 114b together to engage the same to a crown, cap or other dental implant. When the user releases the force on the first handle 112a, 112b and the second handle 114a, 114b, the handles may bias apart, and the elongated beak 116a, 116b may move away from lower beak 122a, 122b, respectively. This may allow the dental apparatuses 110a, 110b to be more easily and effectively used within a patient's mouth.

Specifically, the spring 150a, 150b may comprise a flat, elongated material, preferably a metallic material, although any material may be utilized as apparent to one of ordinary skill in the art. The flat, elongated material may be attached to first handle 112a, 112b and may extend to second handle 114a, 114b, respectively, and engage the same, disposed angularly against the second handle 114a, 114b, such that moving the first handle 112a, 112b toward the second handle 114a, 114b may store potential energy within the spring 150a, 150b, to be released when the force is disengaged from the first handle 112a, 112b, with respect to the second handle 114a, 114b, respectively.

It should be noted that various changes and modifications to the presently preferred embodiments described herein will be apparent to those skilled in the art. Such changes and modifications may be made without departing from the spirit and scope of the present invention and without diminishing its attendant advantages.

What is claimed is:

1. A dental apparatus comprising:
a first handle and a second handle, the first handle being rotatably engaged with the second handle to form a pliers-type apparatus having an open configuration and a closed configuration;
a first elongated beak extending from the first handle, the first elongated beak having a first beak portion angularly extending from the first handle and a second beak portion angularly extending from the first beak portion, the second beak portion having a terminal end for engaging a crown, cap or dental implant; and
a second elongated beak extending angularly from the second handle, wherein the first beak portion and the second elongated beak are parallel to each other when the apparatus is in a closed configuration.

2. The dental apparatus of claim 1, further comprising a terminal end on the second beak portion for engaging the crown, cap or dental implant.

3. The dental apparatus of claim 2, wherein the terminal end has a surface and the surface has a texture.

4. The dental apparatus of claim 3, wherein the texture of the surface comprises a plurality of bumps.

5. The dental apparatus of claim 1, wherein the first beak portion extends at about a ninety degree angle relative to the first handle.

6. The dental apparatus of claim 1, wherein the second beak portion extends at about a ninety degree angle relative to the first beak portion.

7. The dental apparatus of claim 1, wherein the first beak portion extends at about a ninety degree angle relative to the first handle, and the second beak portion extends at about a ninety degree angle relative to the first beak portion.

8. The dental apparatus of claim 1, wherein the second elongated beak extends at about a ninety degree angle relative to the second handle.

9. The dental apparatus of claim 1, further comprising a notch in the second elongated beak for engaging a crown, cap or tooth.

10. A dental system comprising:
a dental apparatus comprising:
a first handle and a second handle, the first handle being rotatably engaged with the second handle to form a pliers-type apparatus having an open configuration and a closed configuration;
a first elongated beak extending from the first handle, the first elongated beak having a first beak portion angularly extending from the first handle and a second beak portion angularly extending from the first beak portion, the second beak portion having a terminal end for engaging a crown, cap or dental implant; and
a second elongated beak extending angularly from the second handle, wherein the first beak portion and the second elongated beak are parallel to each other when the apparatus is in a closed configuration;
a dental implant having a top surface and at least one side, the implant being affixed to a tooth, wherein the second beak portion of the first elongated beak is configured to contact the top surface of the dental implant and the second elongated beak is configured to engages at least one side of the dental implant.

11. The dental system of claim 10, wherein the dental implant is selected from the group consisting of a crown and a cap.

12. A method for using a dental apparatus comprising the steps of:
providing a dental apparatus comprising:
a first handle and a second handle, the first handle rotatably engaged with the second handle to form a pliers-type apparatus having an open configuration and a closed configuration;
a first elongated beak extending from the first handle, the first elongated beak having a first beak portion angularly extending from the first handle and a second beak portion angularly extending from the first beak portion, the second beak portion having a terminal end for engaging a top of a crown, cap or dental implant; and
a second elongated beak extending angularly from the second handle, wherein the first beak portion and the second elongated beak are parallel to each other when the apparatus is in a closed configuration;
engaging the second beak portion of the first elongated beak with a top of the crown, cap or dental implant;
engaging the second elongated beak with a side of the crown, cap or dental implant; and
prying the crown, cap or dental implant from a tooth using the dental apparatus.

13. The method of claim 12, wherein the dental apparatus further comprises a terminal end on the second beak portion for engaging a top of the crown, cap or dental implant.

14. The method of claim 13, wherein the terminal end has a surface and the surface has a texture.

15. The method of claim 14, wherein the texture of the surface comprises a plurality of bumps.

16. The method of claim 12, wherein the first beak portion extends at about a ninety degree angle relative to the first handle.

17. The method of claim 12, wherein the second beak portion extends at about a ninety degree angle relative to the first beak portion.

18. The method of claim 12, wherein the first beak portion extends at about a ninety degree angle relative to the first handle, and the second beak portion extends at about a ninety degree angle relative to the first beak portion.

19. The method of claim 12, wherein the second elongated beak extends at about a ninety degree angle relative to the second handle.

20. The method of claim 12, wherein the dental apparatus further comprises a notch in the second elongated beak for engaging the crown, cap or dental implant.

21. The method of claim 12, wherein the step of prying comprises the step of grasping the first and second handles to impart sufficient pressure and force against the crown, cap or other dental implant to remove the same from a patient's tooth.
